(19) United States
(12) Patent Application Publication
(10) Pub. No.: US 2021/0063143 A1
(43) Pub. Date: Mar. 4, 2021

(54) MULTI-PARAMETER CALCULATION VIA MODAL POWER MEASUREMENTS

(71) Applicant: Honeywell International Inc., Morris Plains, NJ (US)

(72) Inventors: Jeffrey Michael Klein, Minneapolis, MN (US); Mary Katherine Salit, Plymouth, MN (US); Lisa Marie Lust, Minneapolis, MN (US)

(21) Appl. No.: 16/897,924

(22) Filed: Jun. 10, 2020

Related U.S. Application Data
(60) Provisional application No. 62/894,494, filed on Aug. 30, 2019.

(51) Int. Cl. G01B 11/24; G01B 11/26; G01B 11/02

(52) U.S. Cl. CPC G01B 11/2408; G01B 11/02; G01B 11/26

(57) ABSTRACT

A method includes determining an angle of a major axis of an imaged distant sub-diffraction object by obtaining a ratio of measured power of two different optical modes, obtaining power measurements at the angle for three different optical modes, and comparing the power measurements to a catalog of power measurements from one or more known reference objects of known dimensions to determine values for the major axis, a minor axis, and a convexity.

### RELATED APPLICATION

This application claims priority to U.S. Provisional Application Ser. No. 62/894,494 (entitled Multi-Parameter Calculation via Modal Power Measurements, filed Aug. 30, 2019) which is incorporated herein by reference.

### GOVERNMENT FUNDING

This invention was made with Government support under contract FA8650-18-C-9102 awarded by USAF/AFMC. The Government has certain rights in this invention.

### BACKGROUND

A major problem in imaging of small, distant objects is the ability to distinguish or describe basic parameters of objects that are smaller than the imaging system's point spread function (PSF), set by its aperture size. The objects are sub-diffraction and such objects appear unresolved in the case of conventional imaging. In other words, the objects are smaller than the imaging system's PSF-limited resolution. While a larger imaging system, such as a larger-aperture telescope may be used to obtain information about small, distant objects, such larger imaging systems are much more expensive than smaller telescopes.

Prior methods suggest that detection of light in a modal basis by coupling the radiation directly to a device that natively detects optical power in optical modes may allow the estimation of parameters of a sub-diffraction object, such as the object's length. Such techniques may be used to resolve a single parameter. Other techniques are also described for multi-parameter estimation but require interferometric phase measurements.

### SUMMARY

A method includes determining an angle of a major axis of an imaged distant sub-diffraction object by obtaining a ratio of measured power of two different optical modes, obtaining power measurements at the angle for three different optical modes, and comparing the power measurements to a catalog of power measurements from one or more known reference objects of known dimensions to determine values for the major axis, a minor axis, and a convexity.

### BRIEF DESCRIPTION OF THE DRAWINGS

FIG. 1 is a block diagram of a system 100 for obtaining information on small objects according to an example embodiment.

FIG. 2 is a series of images illustrating images of multiple modes, measured power levels, and power ratios obtained for generation of values for three parameters, a length, width, and convexity for a test object according to an example embodiment.

FIG. 3 is a diagram illustrating convexity values for different objects having horizontal bars that are twice as long as the vertical bars of each cross according to an example embodiment.

FIG. 4 is a block diagram illustrating a method of obtaining multiple parameters comprising information about an otherwise PSF blurred out distant object that is sub-diffraction to the optics of the telescope capturing images of the distant object according to an example embodiment.

FIG. 5 is a flowchart illustrating a computer implemented method of obtaining information about a distant object from measurement of power levels of multiple optical modes according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms. “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

The ability to obtain information about small distant objects from information collected by lower PSF resolution telescopes allows a small telescope to effectively replicate some of the functionality of a larger, much more expensive telescope. In various embodiments of the present inventive subject matter, light from one or more objects is detected in a modal basis by coupling the radiation directly to a device that natively detects optical power in optical modes. The optical modes may include, for example but not limited to, the modes of an optical fiber such as Hermite-Gauss or Laguerre. In one embodiment, multiple parameters may be calculated from power measurements of modes.

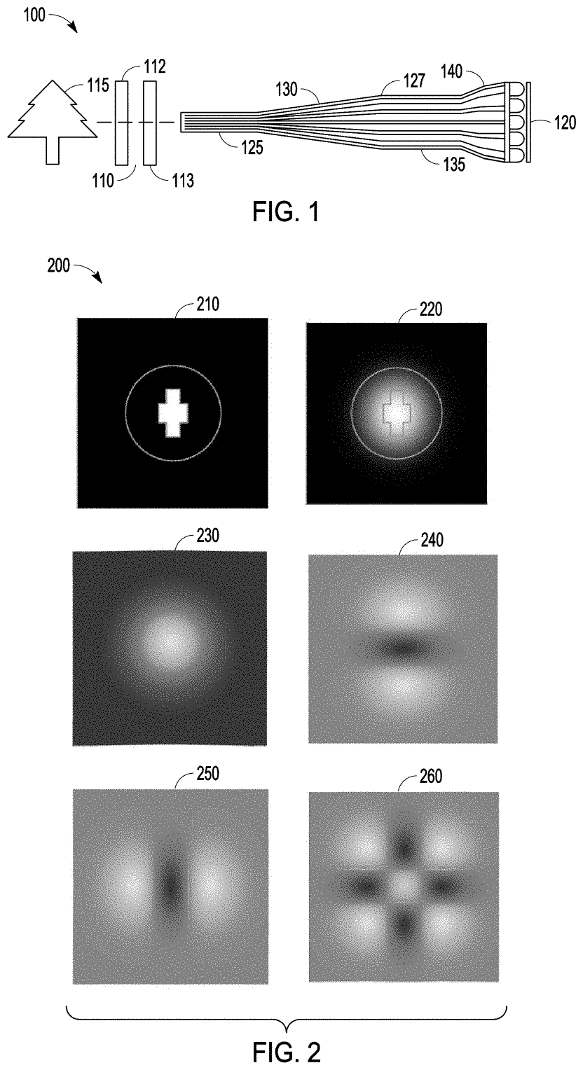

FIG. 1 is a block diagram of a system 100 for obtaining information on small objects. The system 100 includes a telescope 110, represented as at least two lenses 112, 113. Telescope 110 is shown collecting light from a small distant object 115. As FIG. 1 is a block diagram, relative sizes of the elements in FIG. 1 are not representative of actual sizes in implementations of system 100. The collected light is imaged by a mode discrimination device 127 positioned to receive the light collected by the telescope 110. The light is coupled between the telescope and the mode discrimination device 127 via an optical fiber 125, which in one embodiment is part of a photonic lantern. Optical fiber 125 is a multimode fiber in one embodiment which results in different optical modes of light being transmitted.

Photonic lantern 127 receives light from the telescope 110 and carries multiple modes of light via multimode fiber 125. The modes are transitioned at 130 into multiple single mode cores at 135. The number of cores may vary from three or more in various embodiments. The single mode cores 135 fan out at 140 to project light onto the sensors 120. The sensors measure the power in the different modes separately. Depending on the design of the mode discrimination device 127, the sensors may measure signals which are separated in space, time, frequency, polarization, etc. So long as there is some means of discriminating by spatial mode when making power measurements, the measurements are being made in a “modal basis.” The sensors 120 may be photodiode arrays and the mode discrimination device 127 may be a mode sensitive photonic fiber lantern, in one embodiment. In another embodiment, the mode discrimination device may be a rigid waveguide fanout with mode-dependent coupling.

Photonic lantern 127 receives light from the telescope 110 and carries multiple modes of light via multimode fiber 125. The modes are transitioned at 130 into multiple single mode cores at 135. The number of cores may vary from three or more in various embodiments. The single mode cores 135 fan out at 140 to couple to the sensors 120.

In this example, units are dimensionless fractions of the PSF 1/e² diameter, and modes are Hermite-Gauss modes whose power is directly detected by an imaging system that measures power in each of the modes. The modes described and multiple parameters calculated are provided as examples, as a different mode basis and more than four parameters may be calculated in further embodiments to provide information about the object that is not possible to obtain using prior imaging techniques.

Beginning with the object held at the center of an image plane of the imaging device, sensors 120, an angle of the major axis of the object 115 is found, by cycling through a series of boresight angles. The angles may be obtained by rotating the CCD, telescope, optical fiber, or a combination thereof. In one embodiment, a field rotator may be used to obtain different angles to determine the angle of the major axis of the object 115. At each angle, the power in two modes is measured, including a fundamental mode HG00 and a secondary mode HG02. Maximizing the ratio of the measured HG00 and HG02 mode power yields the major axis angle.

FIG. 2 is a series of images 200 illustrating the generation of values for three parameters, a length, width, and convexity or “roundness” for a test object 210. The length and width are commonly described as low-order “moments” of the image). The test object 210 appears as a thickened cross with relative dimensions of 0.3 by 0.5 (fractions of the PSF diameter) corresponding to a convexity or “roundness”. R. of 4. 10 is the maximum possible convexity in one example, however, any scale may be used. Convexity is a measure of deviation from a round object. In other words, the perimeter of the object may contain concave like features that deviate from a perfectly round object. Such deviations from convexity can be measured and used as a parameter to help obtain more information about the object.

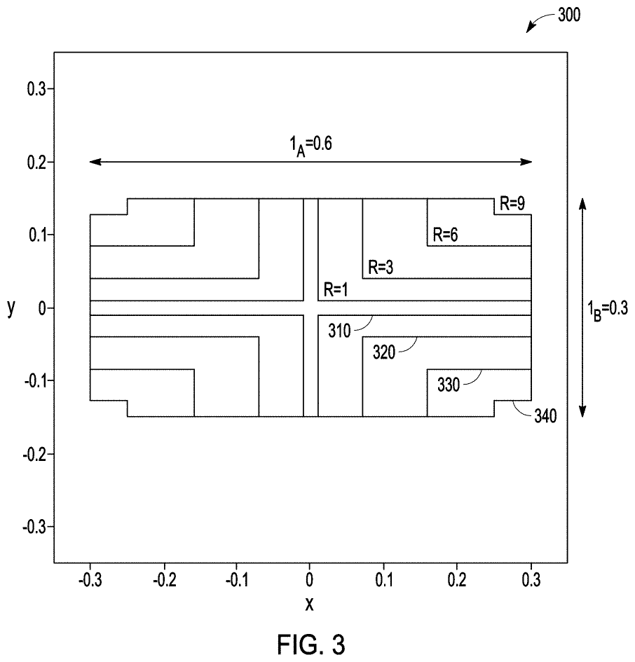

FIG. 3 is a diagram illustrating convexity values, R, for different objects at 300 having horizontal bars that are twice as long as the vertical bars of each cross. The relative corresponding values of length and width are I_{A}=0.6 and I_{B}=0.3. The different objects include cross shaped objects having different thicknesses of the bars forming the crosses. The thinnest bar cross is indicated at 310 and has a convexity of 1. The next thicker bar cross is indicated at 320 and has a convexity of 3. A thicker bar cross 330 has a convexity of 6, and a cross 340 having very thick bars as a convexity of 9.

Referring back to FIG. 2, the image of the test object 210 is convolved with the PSF of the telescope and imaged onto the end of an optical fiber to produce a blurry image 220. The blurry image 220 appears to have lost much of the definition of the length and width of the test object and appears quite round, as we are showing how the object would image onto a conventional imaging plane.

In one embodiment, measured power of three modes, normalized by the primary mode HG00 is used to obtain more information about the object than is obtainable using prior methods for a given PSF of telescope 110. A set of solutions is numerically created to map three parameters—lengths of the major axis (x), the perpendicular minor axis (y), and the parameter that characterizes the convexity of the object (to distinguish between a “+” shaped object and an “o” shaped object, R)—to the normalized power measured in each of three modes. This data set is created once, in advance by overlapping a PSF-blurred example object, in software, with the spatial distributions of the modes that will be measured.

In this example, the mapping for a single instance of length, width, and convexity is found. This process is repeated to fill out the entire parameter space. An image 230 corresponds to the power measured for optical mode HG00. Image 240 corresponds to the power measured for optical mode HG20/HG00 power and in this example is 0.0073. Image 250 corresponds to the power measured for optical mode HG02/HG00 power and in this example is 0.0010. Finally, image 260 corresponds to the power measured for optical mode HG22/HG00 power and in this example is 1.9⁻⁶.

Three 3-dimensional fully-unique data sets are created. Each data set maps the parameters to a power for a given mode of the object. The data sets are then used to reverse the process once a real image is measured, converting three HG00-normalized mode powers to three parameters that describe the sub-diffraction object. Alternatively, the object can be identified by using a look-up library of example objects. Several different known objects may be used and convolved with a selected PSF corresponding to the PSF of the telescope anticipated to be used to image a distant sub-diffraction object. The known objects may be a representative sample of expected potential objects to be imaged to help insure at least one of the known objects may correspond to an imaged distant object. Further known objects may be created by software. Reversing the process to get parameters from the mode powers may be done with a linear solver, such as for example by assuming the measured power and values are proportional. Simulations have been used to show that excellent estimations of parameters of various sub-diffraction test objects have been obtained even when shot noise is added to the modal power measurements.

Roughly, HG00 and HG20 are sensitive to the moment of inertia in the vertical and horizontal directions, while HG22 is sensitive to the rectangular vs. on-axis nature of the object, although they are not fully independent. Fully constructed, there are three data sets, each that maps the three parameters to the measured power in the three modes HG02, HG20, and HG22. Other modes, or another modal basis may be used in further embodiments.

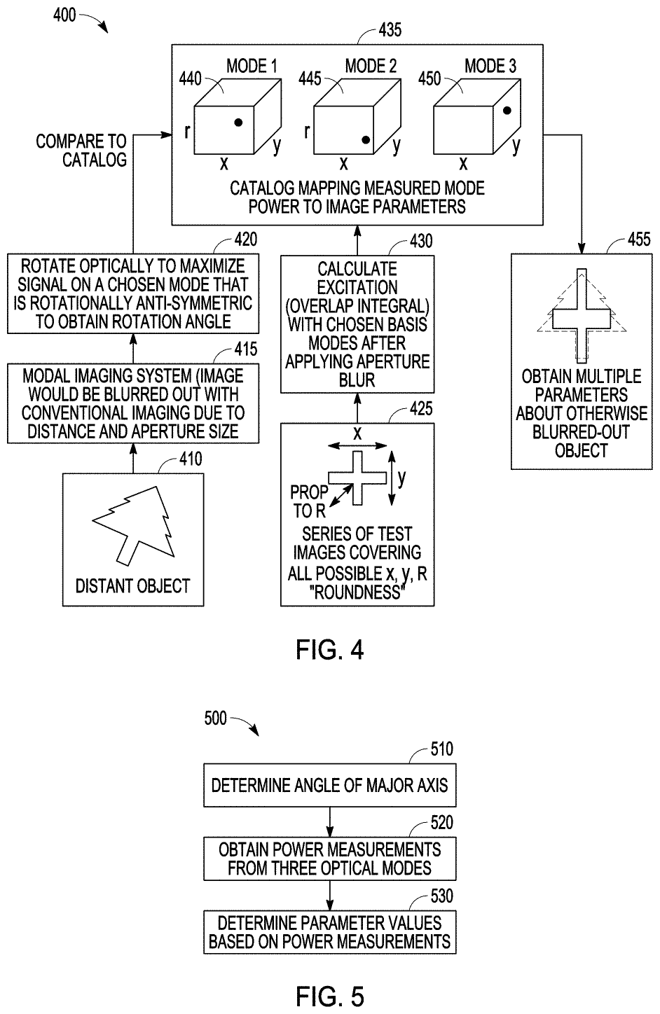

FIG. 4 is a block diagram illustrating a method 400 of obtaining multiple parameters comprising information about an otherwise PSF blurred out distant object 410 that is sub-diffraction to the optics of the telescope capturing images of the distant object. At 415, modal images are captured, such as by system 100. Normally, the image would be blurred out by diffraction with conventional imaging due to the distance and aperture size of the telescope or other imaging system. System 100 then optically rotates the image to maximize a power measurement signal on a selected mode that is rotationally antisymmetric to obtain a rotation angle corresponding to the major axis of the object. Power measurements on all the modes are then performed.

To calibrate the system 100, a series of test images covering the length, width, and convexity of a known test object are captured at 425 and blurred using the PSF of the telescope 110. The measured power levels at different modes are then associated at 430 with the actual dimensions of the test object and stored in a catalog 435. The measured power and corresponding known parameters from the test object are stored for each mode as indicated at mode 1440, mode 2 445, and mode 3 450. In one embodiment, the measured power levels in the different modes of the distant object 410 are compared to the information in the catalog, and the parameters of the distant object may be extrapolated from such information. In further embodiments, the catalog contains power levels and corresponding parameter values for multiple different test objects, and the parameters of the test object having power levels most closely matching the measured power levels of the distant object may be used to estimate the parameter of the distant object.

FIG. 5 is a computer implemented method 500 of determining parameters corresponding to PSF blurred images of a distant object. Method 500 starts at operation 510 by determining an angle of a major axis of an imaged distant sub-diffraction object by obtaining a ratio of measured power of two different optical modes. Determining an angle may be performed by rotating the object to maximize a signal on a chosen mode that is rotationally antisymmetric. The angle may also be determined by rotating the image through a series of angles and selecting the angle with the highest ratio. The images of sub-diffraction object may be provided by a telescope focusing an image of the object onto an optical multimode fiber tip and projecting the modes from the fiber onto optical detectors.

In one embodiment the two different optical modes comprise a fundamental mode and a secondary mode. Operation 520 obtains power measurements at the angle for three different optical modes. The three different optical modes in one embodiment are Hermite-Gauss modes or Laguerre modes. The Hermite-Gauss modes comprise a primary mode HG00, a secondary mode HG02, and an HG22 mode. The power measured in each mode may optionally be normalized to the HG00 mode measured power.

Operation 530 compares the power measurements to a catalog of power measurements from one or more known objects to determine values for the major axis, a minor axis, and a convexity. The convexity in one embodiment is measured on a scale of 0-10, with 10 being a maximum convexity. The catalog of power measurements in one embodiment includes power measurements for one or more known objects at all three modes and corresponding values for the major axis, minor axis, and convexity for each mode. The values are determined by mapping the obtained power measurements to the values based on the power measurements and known values for one known object. The values may be determined as a function of one of the known objects having power measurements closest to the obtain power measurements.

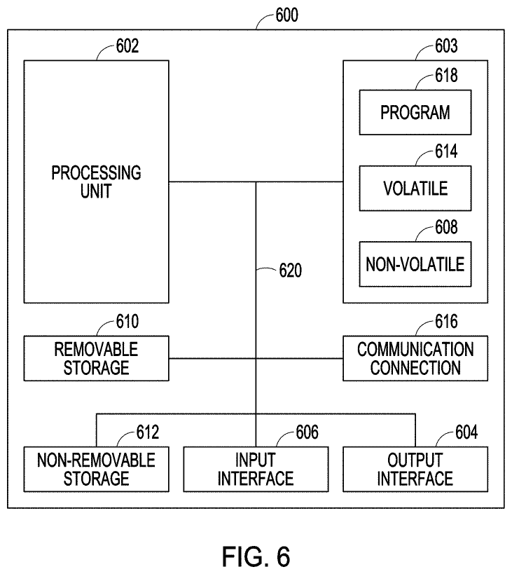

FIG. 6 is a block schematic diagram of a computer system 600 to implement and manage the use of flexible workspaces and for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to process captured images in multiple modes and determine parameters of distant objects. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 618 along with the workspace manager 622 may be used to cause processing unit 602 to perform one or more methods or algorithms described herein.

### Examples

1. A method includes determining an angle of a major axis of an imaged distant sub-diffraction object by obtaining a ratio of measured power of two different optical modes, obtaining power measurements at the angle for three different optical modes, and comparing the power measurements to a catalog of power measurements from one or more known reference objects of known dimensions to determine values for the major axis, a minor axis, and a convexity.

2. The method of example 1 wherein the two different optical modes comprise a fundamental mode and a secondary mode.

3. The method of any of examples 1-2 wherein determining an angle is performed by rotating the object to maximize a signal on a chosen mode that is rotationally antisymmetric.

4. The method of any of examples 1-3 wherein the three different optical modes comprise Hermite-Gauss modes or Laguerre modes.

5. The method of example 4 wherein the Hermite-Gauss modes comprise a primary mode HG00, a secondary mode HG02, and an HG22 mode.

6. The method of example 5 wherein the power measured in each mode is normalized to the HG00 mode measured power.

7. The method of any of examples 1-6 wherein the convexity is measured on a predetermined convexity scale.

8. The method of any of examples 1-7 wherein the catalog of power measurements comprises power measurements for one or more known objects at all three modes and corresponding values for the major axis, minor axis, and convexity for each mode.

9. The method of example 8 wherein the values are determined by mapping the obtained power measurements to the values based on the power measurements and known values for one known object.

10. The method of any of examples 8-9 wherein the values are determined as a function of one of the known objects having power measurements closest to the obtain power measurements.

11. The method of any of examples 1-10 wherein the sub-diffraction object is imaged by a telescope focusing an image of the object onto an optical multimode fiber tip and projecting the modes from the fiber onto optical detectors.

12. The method of example 11 wherein determining an angle comprises rotating through a series of angles and selecting the angle with the highest ratio.

13. A machine-readable storage device has instructions for execution by a processor of a machine to cause the processor to perform operations to perform a method. The operations include determining an angle of a major axis of an imaged distant sub-diffraction object by obtaining a ratio of measured power of two different optical modes, obtaining power measurements at the angle for three different optical modes, and comparing the power measurements to a catalog of power measurements from one or more known objects to determine values for the major axis, a minor axis, and a convexity.

14. The device of example 13 wherein the two different optical modes comprise a fundamental mode and a secondary mode.

15. The device of any of examples 13-14 wherein determining an angle is performed by rotating the object to maximize a signal on a chosen mode that is rotationally antisymmetric.

16. The device of any of examples 13-15 wherein the catalog of power measurements comprises power measurements for one or more known objects at all three modes and corresponding values for the major axis, minor axis, and convexity for each mode.

17. The device of example 16 wherein the values are determined by mapping the obtained power measurements to the values based on the power measurements and known values for one known object.

18. The device of any of examples 16-17 wherein the values are determined as a function of one of the known objects having power measurements closest to the obtain power measurements.

19. A device includes a processor and a memory device coupled to the processor and having a program stored thereon for execution by the processor to perform operations. The operations include determining an angle of a major axis of an imaged distant sub-diffraction object by obtaining a ratio of measured power of two different optical modes, obtaining power measurements at the angle for three different optical modes, and comparing the power measurements to a catalog of power measurements from one or more known objects to determine values for the major axis, a minor axis, and a convexity.

20. The device of example 19 wherein the catalog of power measurements comprises power measurements for one or more known objects at all three modes and corresponding values for the major axis, minor axis, and convexity for each mode, and wherein the values are determined by mapping the obtained power measurements to the values based on the power measurements and known values for one known object.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
determining an angle of a major axis of an imaged distant sub-diffraction object by obtaining a ratio of measured power of two different optical modes;
obtaining power measurements at the angle for three different optical modes; and
comparing the power measurements to a catalog of power measurements from one or more known reference objects of known dimensions to determine values for the major axis, a minor axis, and a convexity.

2. The method of claim 1 wherein the two different optical modes comprise a fundamental mode and a secondary mode.

3. The method of claim 1 wherein determining an angle is performed by rotating the object to maximize a signal on a chosen mode that is rotationally antisymmetric.

4. The method of claim 1 wherein the three different optical modes comprise Hermite-Gauss modes or Laguerre modes.

5. The method of claim 4 wherein the Hermite-Gauss modes comprise a primary mode HG00, a secondary mode HG02, and an HG22 mode.

6. The method of claim 5 wherein the power measured in each mode is normalized to the HG00 mode measured power.

7. The method of claim 1 wherein the convexity is measured on a predetermined convexity scale.

8. The method of claim 1 wherein the catalog of power measurements comprises power measurements for one or more known objects at all three modes and corresponding values for the major axis, minor axis, and convexity for each mode.

9. The method of claim 8 wherein the values are determined by mapping the obtained power measurements to the values based on the power measurements and known values for one known object.

10. The method of claim 8 wherein the values are determined as a function of one of the known objects having power measurements closest to the obtain power measurements.

11. The method of claim 1 wherein the sub-diffraction object is imaged by a telescope focusing an image of the object onto an optical multimode fiber tip and projecting the modes from the fiber onto optical detectors.

12. The method of claim 11 wherein determining an angle comprises rotating through a series of angles and selecting the angle with the highest ratio.

13. A machine-readable storage device having instructions for execution by a processor of a machine to cause the processor to perform operations to perform a method, the operations comprising:
determining an angle of a major axis of an imaged distant sub-diffraction object by obtaining a ratio of measured power of two different optical modes;
obtaining power measurements at the angle for three different optical modes; and
comparing the power measurements to a catalog of power measurements from one or more known objects to determine values for the major axis, a minor axis, and a convexity.

14. The device of claim 13 wherein the two different optical modes comprise a fundamental mode and a secondary mode.

15. The device of claim 13 wherein determining an angle is performed by rotating the object to maximize a signal on a chosen mode that is rotationally antisymmetric.

16. The device of claim 13 wherein the catalog of power measurements comprises power measurements for one or more known objects at all three modes and corresponding values for the major axis, minor axis, and convexity for each mode.

17. The device of claim 16 wherein the values are determined by mapping the obtained power measurements to the values based on the power measurements and known values for one known object.

18. The device of claim 16 wherein the values are determined as a function of one of the known objects having power measurements closest to the obtain power measurements.

19. A device comprising:
a processor; and
a memory device coupled to the processor and having a program stored thereon for execution by the processor to perform operations comprising:
determining an angle of a major axis of an imaged distant sub-diffraction object by obtaining a ratio of measured power of two different optical modes;
obtaining power measurements at the angle for three different optical modes; and
comparing the power measurements to a catalog of power measurements from one or more known objects to determine values for the major axis, a minor axis, and a convexity.

20. The device of claim 19 wherein the catalog of power measurements comprises power measurements for one or more known objects at all three modes and corresponding values for the major axis, minor axis, and convexity for each mode, and wherein the values are determined by mapping the obtained power measurements to the values based on the power measurements and known values for one known object.
